(19) United States
(12) Patent Application Publication
(10) Pub. No.: US 2008/0079979 A1
(43) Pub. Date: Apr. 3, 2008

(54) System and method for securing a document

(76) Inventors: David Lowell Holt, Hendersonville, TN (US); Bruce Edwin Ballard, Morton, IL (US); Victoria Beecher Holt, Hendersonville, TN (US)

Correspondence Address: CATERPILLAR/FINNEGAN, HENDERSON, L.L.P., 901 New York Avenue, NW, WASHINGTON, DC, 20001-4413, US

(21) Appl. No.: 11/529,643

(22) Filed: Sep. 29, 2006

(51) Int. Cl. G06K 15/00

(52) U.S. Cl. 358/1.14

(57) ABSTRACT

A system is disclosed that provides for selectively securing an electronic document, the electronic document having the appearance of a paper-based form. The system has a display and a memory, the memory including program code for selectively securing an electronic document, wherein the electronic document has one or more portions. The system also has a processor configured to execute the program code to provide the electronic document to a user and to provide at least one selectable area within the electronic document, wherein the selectable area is associated with at least one of the one or more portions. The processor is also configured to selectively control the ability to alter the at least one portion based on a selection of the associated one or more selectable areas.

### TECHNICAL FIELD

The present disclosure relates generally to a system and method for securing documents, and more particularly, to systems and methods for selectively securing portions of an electronic document.

### BACKGROUND

Businesses often use forms and documents in the course of conducting day-to-day business operations. For example, a business, as well as its customers, suppliers, and others involved with the business, may complete various forms and documents as a part of the business relationship, such as customer applications for a product or service, supplier documentation and correspondence, and responses to applications and correspondence. Businesses further require the ability to manage, control, and/or track these forms and documents. One such example is extended services coverage (ESC) agreements. Extended services coverage may typically be in the form of an insurance, warranty, guarantee, indemnity, and other similar agreements. Such agreements require customers to apply for an extended services coverage, businesses to respond to the application, and customers to accept or decline to response. The offer and acceptance process for extended services coverage has traditionally required the use of paper-based documents. However, electronic documents are increasingly being used to replace this paper-based processing. Electronic documents allow businesses to improve quality and reduce the time and costs associated with paper-based documents, e.g., reducing the time required to move paper-based documents from person to person, minimizing data entry errors, and improving compilation and storage of data contained on the documents. Electronic documents which can be secured or locked provide increased compliance with regulatory requirements as well as improved tracking and auditing.

Systems and methods have been created to automatically lock electronic documents. One such example is U.S. Patent Publication Number 2004/0158587 (the '587 publication) to Shay et al. and published on Aug. 12, 2004. The '587 publication discloses a computer-implemented method for controlling document edits. In the '587 publication, an entire document may be locked by either a click-and-drag action or by a mouse-click, thus preventing the document from further edits.

Although the system and method of the '587 publication may enable an entire document to be locked, the system and method do not offer a way to lock only portions of a document. Thus, the system of the '587 publication does not provide mechanisms to selectively edit locked portions of a single document.

The disclosed system is directed to overcoming one or more of the problems set forth above.

### SUMMARY OF THE INVENTION

In one aspect, the present disclosure is directed to a system for securing an electronic document, the electronic document having the appearance of a paper-based form. The system includes a display and a memory, the memory including program code for selectively securing an electronic document, wherein the electronic document has one or more portions. The system also includes a processor configured to execute the program code to provide the electronic document to a user and to provide at least one selectable area within the electronic document, wherein the selectable area is associated with at least one of the one or more portions. The processor is also configured to selectively control the ability to alter the at least one portion based on a selection of the associated one or more selectable areas.

In another aspect, the present disclosure is directed to a method for securing an electronic document, the electronic document having the appearance of a paper-based form. The method includes providing the electronic document to a user, wherein the electronic document includes one or more portions. The method further provides at least one selectable area within the electronic document, wherein the selectable area is associated with at least one of the one or more portions. The method also receives a selection of the at least one or more selectable areas by the user and selectively controls the ability to alter the at least one portion based on the user's selection of the associated one or more selectable areas.

### BRIEF DESCRIPTION OF THE DRAWINGS

FIG. 1 is a block diagram of an exemplary system consistent with certain disclosed embodiments;

FIGS. 2a and 2b are block diagrams of exemplary systems for securing the form consistent with certain disclosed embodiments;

FIG. 3 is a flow chart illustrating an exemplary process for securing an electronic document consistent with certain disclosed embodiments;

FIG. 4 is a flow chart illustrating an exemplary process for securing an electronic document consistent with certain disclosed embodiments; and

FIG. 5 is a screenshot illustrating an exemplary electronic document consistent with certain disclosed embodiments.

### DETAILED DESCRIPTION

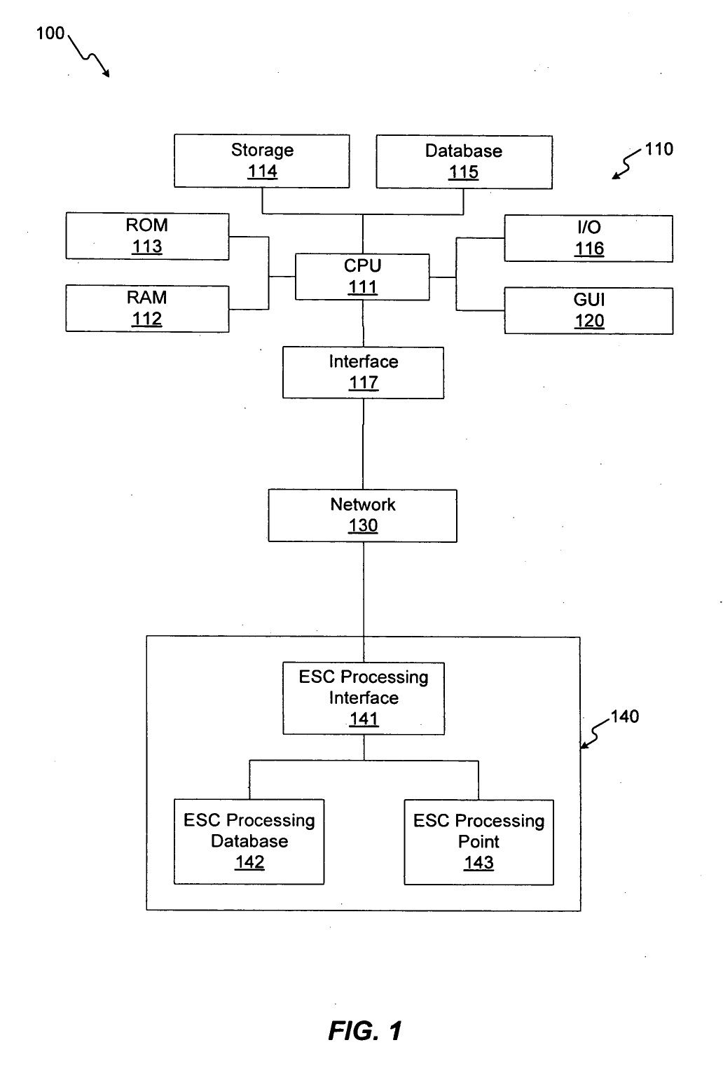

FIG. 1 illustrates an exemplary system architecture 100 in which principles and methods consistent with the disclosed embodiments may be implemented. As shown in FIG. 1, system architecture 100 may include one or more hardware and/or software components configured to display, collect, store, analyze, evaluate, distribute, report, process, record, and/or sort information associated with electronic documents and forms and, in particular, extended services coverage (ESC) documents. System architecture 100 may include computer system 110, network 130, and ESC processing system 140.

Computer system 110 may be configured to receive, collect, analyze, evaluate, report, display, and distribute data related to electronic documents using one or more hardware and/or software components such as, for example, a central processing unit (CPU) 111, a random access memory (RAM) 112, a read-only memory (ROM) 113, a storage 114, a database 115, one or more input/output (I/O) devices 116, interface 117, and one or more graphical user interfaces (GUI) 120. Computer system 110 may be a desktop, laptop, personal digital assistant (PDA), cellular phone, pager, and the like. For example, computer system 110 may be a laptop configured to display electronic documents, receive input for editing the electronic documents, validate the input data, compile the input data, and forward the data from the electronic documents.

CPU 111 may include one or more processors, each configured to execute instructions and process data to perform functions associated with computer system 110. As illustrated in FIG. 1, CPU 111 may be communicatively coupled to RAM 112, ROM 113, storage 114, database 115, I/O devices 116, and interface 117. CPU 111 may be configured to execute computer program instructions to perform various processes and methods consistent with certain disclosed embodiments. In one exemplary embodiment, computer program instructions may be loaded into RAM 112 for execution by CPU 111.

RAM 112 and ROM 113 may each include one or more devices for storing information associated with an operation of computer system 110 and/or CPU 111. For example, ROM 113 may include a memory device configured to access and store information associated with computer system 110, including information for identifying, initializing, and monitoring the operation of one or more components and subsystems of computer system 110. RAM 112 may include a memory device for storing data associated with one or more operations of CPU 111. For example, instructions stored on ROM 113 may be loaded into RAM 112 for execution by CPU 111.

Storage 114 may include any type of storage device configured to store any type of information used by CPU 111 to perform one or more processes consistent with the disclosed embodiments. Storage 114 may include one or more magnetic and/or optical disk devices, such as, for example, hard drives, CD-ROMs, DVD-ROMs, a universal serial bus (USB) port, a floppy, or any other type of storage media device.

Database 115 may include one or more software and/or hardware components that store, organize, sort, filter, and/or arrange data used by computer system 110 and/or CPU 111. For example, database 115 may store historical information associated with electronic documents, such as, for example, document data, valid field values, validation parameters, and the like that may be used by CPU 111 to display, save, send, or otherwise process electronic documents. Database 115 may store additional and/or different information than that listed above. For example, database 115 may contain registration numbers, registration forms, and/or a registration database which may be associated with one or more electronic documents, and the one or more electronic documents may be correlated with information in the registration database or the like. Alternatively and/or additionally, database 115 may contain registration numbers, registration forms, and/or a registration database which may be associated with one or more data fields associated with the one or more electronic documents and these data fields may be correlated with information in the registration database.

I/O devices 116 may include one or more components configured to communicate information with a user associated with computer system 110. For example, I/O devices 116 may include a console with an integrated keyboard and mouse to allow a user to input parameters associated with computer system 110 and/or data associated with electronic documents. Additionally, I/O devices 116 may include one or more displays or other peripheral devices, such as, for example, a printer, a camera, a microphone, a speaker system, an electronic tablet, or any other suitable type of input/output device.

Interface 117 may include one or more components configured to transmit and receive data via network 130, such as, for example, one or more modulators, demodulators, multiplexers, de-multiplexers, network communication devices, wireless devices, antennas, modems, and any other type of device configured to enable data communication via any suitable communication network. It is further anticipated that interface 117 may be configured to allow CPU 111, RAM 112, ROM 113, storage 114, database 115, and one or more input/output (I/O) devices 116 to be located remotely from one another and perform the method of collection, analysis, and distribution of data or other information associated with electronic forms.

GUI 120 may enable access to and interaction with computer system 110. In the illustrated embodiment, GUI 120 may be used to display an electronic document and allow data to be edited, selected, or entered into the fields of the electronic document. It is contemplated that other communication means and/or protocols may replace and/or be used in association with GUI 120, such as, for example, text interfaces, voice systems, PDA protocols, etc. to allow a user to interact with computer system 110.

Computer system 110 may include additional, fewer, and/or different components than those listed above and it is understood that the listed components are exemplary only and not intended to be limiting. For example, one or more of the hardware components listed above may be implemented using software such as, for example, storage 114 may include a software partition associated with one or more other hardware components of computer system 110. Additional hardware or software may also be used to operate computer system 110, such as, for example, security applications, authentication systems, dedicated communication systems, etc. The hardware and/or software may be interconnected and accessed as required by authorized users. In addition, a portion, or all of, computer system 110 may be hosted and/or operated by a third party, such as, for example, commercial servers and/or application providers.

As discussed above, computer system 110 may be in communication with network 130 by means of interface 117. Network 130 may be any appropriate communication network allowing communication between or among one or more entities, such as, for example, the Internet, a local area network, a workstation peer-to-peer network, a direct link network, a wireless network, or any other suitable communication network. Connection with network 130 may be wired, wireless, or any combination thereof.

ESC processing system 140 may be any computer-based system supporting an organization or entity responsible for, in whole or in part, processing electronic documents and/or the data associated with electronic documents. In one exemplary embodiment, ESC processing system 140 may support an entity responsible for collecting, monitoring, storing, analyzing, evaluating, distributing, reporting, processing, recording, and/or sorting information associated with extended services coverage (ESC), such as, for example, an insurer, warrantor, and the like.

ESC processing system 140 may include an ESC processing interface 141, ESC processing database 142, and ESC processing point 143. ESC processing system 140 may also include one or more computing devices (i.e., desktop computer, laptop computer, mainframe computer, handheld computing device, etc.) and various other hardware or software components (not shown).

ESC processing interface 141 may include one or more components configured to transmit and receive data between network 130 and processing system 140. ESC processing interface 141 may be further configured to route incoming data within ESC processing system 140. Specifically, ESC processing interface 141 may allow data to be transmitted and routed between computer system 110 and ESC processing system 140, which may include ESC processing database 142 and ESC processing point 143. In addition, ESC processing interface 141 may be configured to allow ESC processing database 142 and ESC processing point 143 to be located remotely from one another and perform the disclosed method of securing and/or unsecuring electronic documents.

ESC processing database 142 may include a relational, distributed, or any other suitable database format. A relational database may be in tabular form where data may be reorganized and accessed in various ways. A distributed database may be dispersed or replicated among different locations within a network. ESC database 142 may store information, such as, for example, display profiles and properties, user information and profiles, previously entered data, metadata, and the like, associated with processing electronic ESC documents. Further, ESC processing database 142 may include analysis tools for analyzing information within the database.

ESC processing point 143 may include any computing system configured to allow access to ESC processing system 140, ESC processing interface 141, and ESC processing database 142. Specifically, any one or more suitably configured and authorized computer systems may function as ESC processing point 143 and thereby access processing system 140, ESC processing interface 141, and ESC processing database 142.

### INDUSTRIAL APPLICABILITY

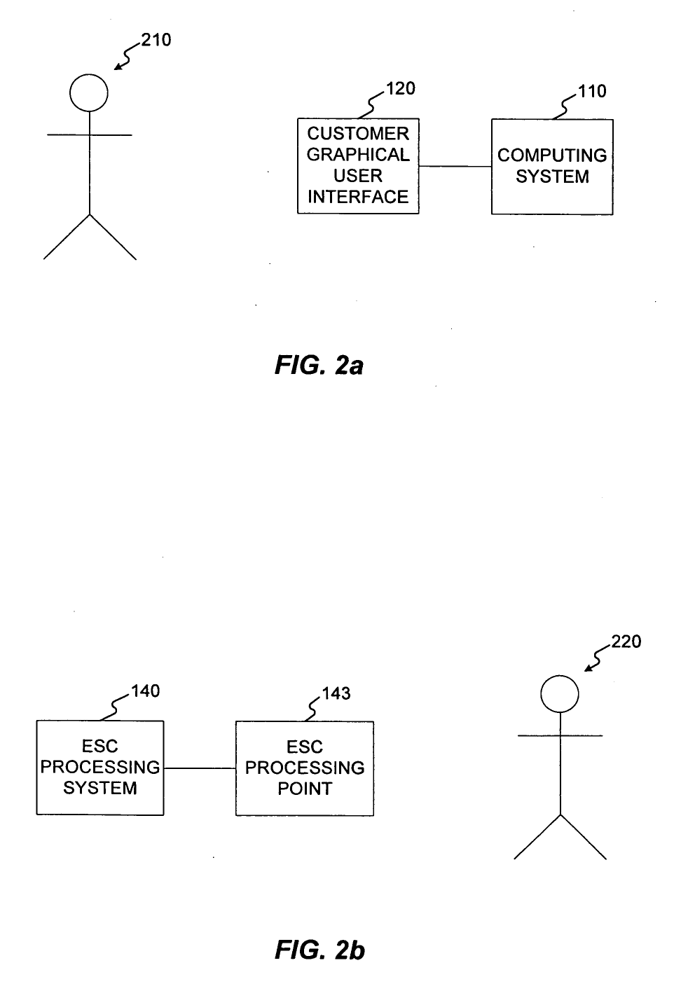

FIG. 2a shows an example where a user 210 desiring to purchase extended services coverage may utilize graphical user interface (GUI) 120 to access an electronic document on computing system 110. The electronic document may be displayed using, for example, an I/O device 116 on computing system 110. The electronic document may be an electronic form having the appearance of a paper-based document. The user 210 may further utilize one or more I/O devices 116 to enter data into the electronic document, such as, for example, a touch-screen, mouse, or keyboard associated with computing system 110. Entry of data into the electronic document may have the “look and feel” of data entry into paper-based forms, e.g., a non-editable string of text or letters followed by an editable field. The user 210 may be, for example, a current or potential purchaser of extended services coverage, a dealer, a supplier, and the like.

As shown in FIG. 2b, an agent 220 may access ESC processing system 140 by means of ESC processing point 143 to view, edit, or otherwise process the electronic document submitted by user 210. The agent 220 may be, for example, an employee, contractor, or similar person authorized to access ESC processing point 141 and process electronic documents.

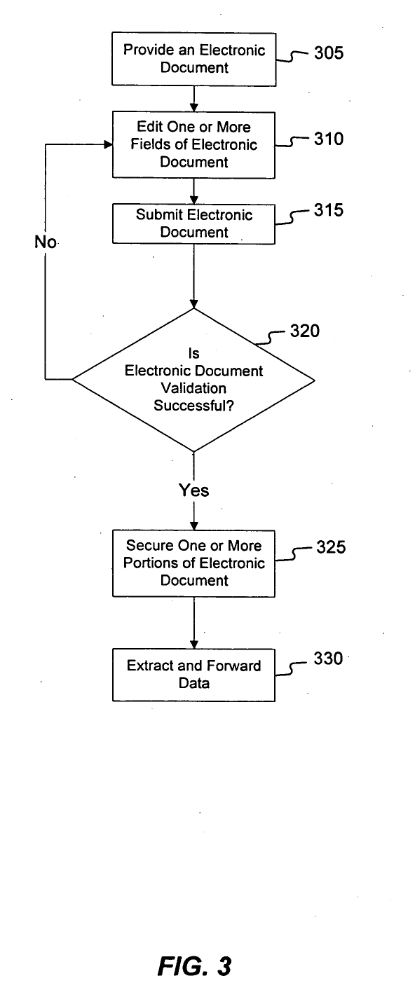

FIG. 3 illustrates a flowchart of an exemplary process for securing electronic documents consistent with certain disclosed embodiments. The process of FIG. 3 may be performed by computing system 110. For example, as discussed with respect to FIG. 2a, a user 210 may access computing system 110 which may, in turn, execute one or more software programs that may perform the process steps of FIG. 3.

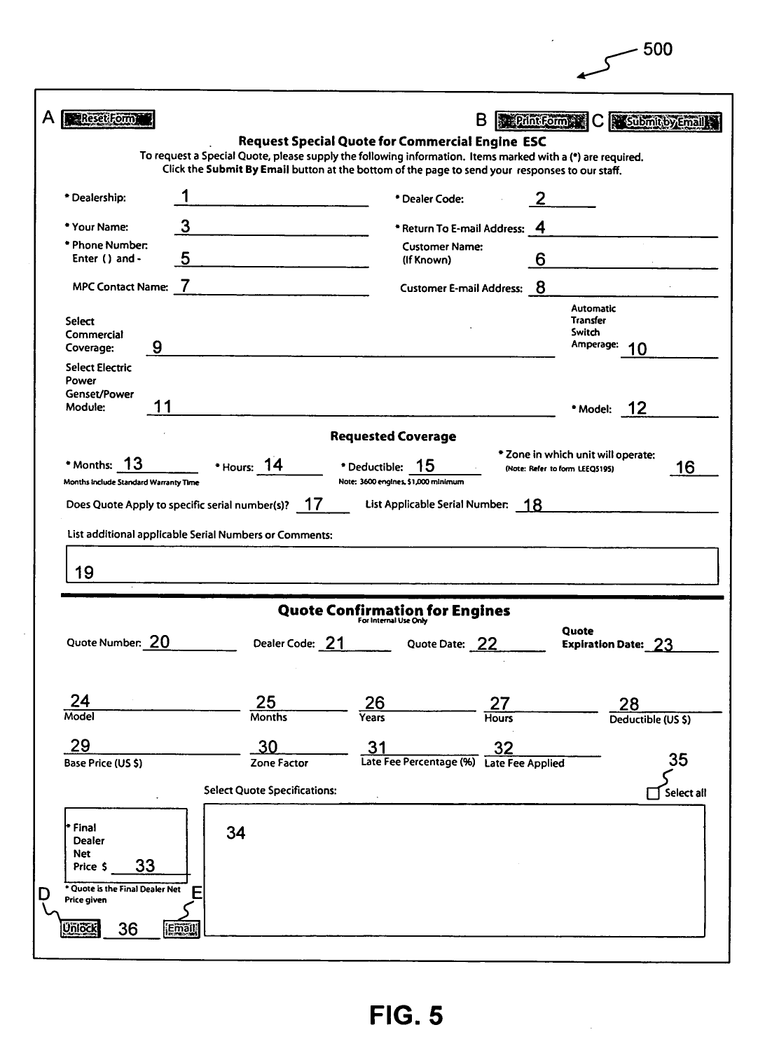

As shown in step 305, computing system 110 may provide an electronic document on an I/O device 116, such as a display. The electronic document may have one or more discrete editable fields including, for example, drop-down boxes, alphanumeric entry fields, radio buttons, check boxes, scrollable lists, menu bars, and the like. In addition, the electronic document may contain letters, words, pictures, graphics, portions, etc. which may appear in the electronic document but which may not be editable by user 210. For example, referring to the exemplary document of FIG. 5, items 1-36 may be editable fields whereas the other text and graphics, with the exception of items A-E, may be uneditable and inaccessible by user 210. The one or more editable fields may be logically grouped together to form one or more portions in the electronic document. Access to each of these one or more portions may be restricted or controlled by means of activating or selecting one or more selectable areas within the electronic document. The one or more selectable areas may be, for example, buttons, radio buttons, check boxes, scrollable lists, menu list, and the like, and may control access to one or more portions of the electronic document by securing and/or unsecuring the one or more portions of the electronic document. In the exemplary embodiment, the selectable area may be represented by a button. Alternatively and/or additionally, any one or more of the selectable areas may be accompanied by an editable field for entering a password or identification, thus allowing the document to be unsecured only upon entry of a valid password and/or identification coupled with selection of the associated button. A password or identification may include any combination of letters, numbers, and symbols. Alternatively and/or additionally, other means of verification may be used, such as, for example, voice recognition, identification card/card reader, biometric verification, and the like.

For example, referring to FIG. 5, in an exemplary embodiment, an electronic document may include thirty-six editable fields, items 1-36, which may, in turn, be grouped into three portions. A first portion of the exemplary electronic document may consist of items 1-19 and may be selectively secured and/or unsecured by any one or more buttons, such as, for example, item C. A second portion of the electronic document may consist of items 20-36 and may be selectively secured and/or unsecured by any one or more buttons, such as, for example, item D. A third portion of the electronic document may consist of all the editable fields, e.g., items 1-36, and may be selectively secured and/or unsecured by any one or more buttons, such as, for example, item E. In the exemplary electronic document, a password may be required for unsecuring the second portion of the form, e.g., item 36.

At step 310, one or more fields of an electronic document may be edited by entering and/or selecting the requested data. In some embodiments, the user 210 may be required to edit a specific number of fields and/or the user 210 may be limited to certain entries or data types in predetermined fields, such as, for example, only letters, only numbers, only alphanumeric characters, only certain number and/or letter combinations, specific numbers of characters, specific format, and the like. In addition, the user 210 may be required to enter data based on previously entered data.

Once the data entry is complete, the button associated with submitting the edited portion of the electronic document (step 315) may be selected. For example, referring to FIG. 5, the user 210 may edit items 1-19, associated with a first portion of the electronic document, and then may select the button associated with submitting the first portion of the electronic document, e.g., item C.

When the selectable area for submitting the electronic document is selected, validation of the editable fields may be initiated (step 320). For example, any dependencies or relationships between the editable fields may be reconciled and/or the data contained within the editable fields may be evaluated to determine if the entered data exhibits a predefined set of characteristics. Referring to the exemplary electronic document of FIG. 5, the dealer code (item 2), e-mail addresses (items 4 and 6), and phone number (item 5) may be validated to ensure that they are in an expected format; the zone (item 16) may be validated to ensure it is a valid number; the months (13), hours (item 14), and deductible (item 16) may be validated to ensure they fall within a predetermined range of values; the commercial coverage (item 9), amperage (item 10), module (item 11), and model (item 12) may be validated in relation to one another; and the remaining fields may be validated to simply ensure that they contain data.

If the data validation is unsuccessful (step 320, No), e.g., the data is incomplete or inconsistent, then processing may return to step 310 and the user 210 may be allowed to alter or amend the data contained in any of the editable fields. Alternatively, if the data is successfully validated (step 320, Yes), processing may move to step 325. It is anticipated that, in some embodiments, it may be undesirable or unnecessary to validate the editable fields. If validation is not performed, processing may skip validation and move to step 325.

In step 325, one or more portions of the electronic document may be secured. When the one or more portions of the electronic document is secured, the ability to alter, amend, or revise the secured one or more portions of the electronic document may be restricted or inhibited. Alternatively, when the one or more portions of the electronic document is unsecured, the ability to alter, amend, or revise those one or more portions of the electronic document may be unrestricted. In some embodiments, it is envisioned that one or more portions of the electronic document may be unsecured while, at the same time, another one or more portions may be secured. For example, referring to FIG. 5, selection of item C may result in the portion of the electronic document containing items 1-19 to be secured while items 20-36 remain unsecured. In some embodiments, once a portion has been secured, that portion may not be unsecured. For example, referring again to FIG. 5, selection of item C may permanently maintain the data entered into items 1-19 and prevent future editing of the data associated with items 1-19 from within the electronic document.

Once the electronic document is secured, data may be extracted from the electronic document, inserted into a data file, and forwarded through network 130 (step 330). In some embodiments, it is anticipated that the data may be extracted, parsed, and forwarded through any means known in the art that may be applicable to the type of computing device used, such as, for example, HyperText Markup Language (HTML), Simple Mail Transfer Protocol (SMTP), File Transfer Protocol (FTP), Post Office Protocol (POP), Extensible Markup Language (XML), Transmission Control Protocol/Internet Protocol (TCP/IP), Wireless Markup Language (WML), Wireless Application Protocol (WAP), Wireless Markup Language Script (WMLScript), Wireless Telephony Application Interface (WTAI), and the like. In the exemplary embodiment, the data is extracted from the electronic document, inserted into the subject line of an electronic mail, and sent to ESC processing system 140 by means of network 130.

Referring to the exemplary electronic document in FIG. 5, user 210 may enter data into items 1-19 of the electronic document (step 310 of FIG. 3) and then may select item C, the button labeled “Submit by Email” (step 315). The selection of item C may begin validation of the electronic document (step 320). If the electronic document validation fails (step 320, No), the electronic document will remain unsecured and the user 210 may be prompted to correct one or more data fields of the electronic document. Once validation is complete (step 320, Yes), the electronic document is secured (step 325) and the user 210 may be unable to make any more changes or edits to the electronic document. In addition, the data contained in fields 1-20 may be extracted and placed in a data file (step 330). In the exemplary embodiment, certain data fields may be parsed and placed in the subject line of an email, and the return email address (item 4) may be placed in the sender's line of the email. In addition, other data contained in the electronic document, but which may not be visible to a user 210, may be extracted and inserted into the email, such as, for example, the recipient's email address, metadata, and the like. In some embodiments, it is envisioned that the remaining data may be placed into the body of the email or otherwise attached to the email as a data file. Once the data has been extracted from the electronic document and placed in an email, the email may then be sent to the email address inserted into the recipient's address line.

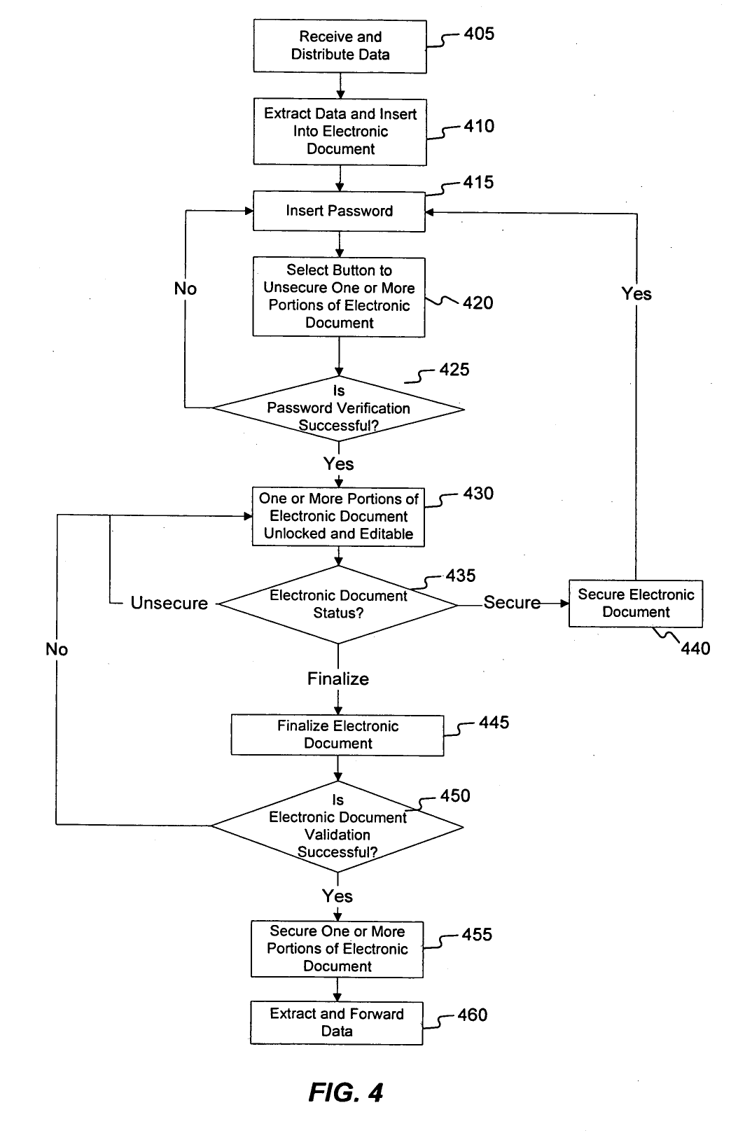

Referring now to FIG. 4, once the electronic document data has been received by ESC processing system 140, ESC processing interface 141 may distribute the data to ESC processing database 142 and/or ESC processing point 143 (step 405). For example, when ESC processing system 140 receives data from a user 210, ESC processing interface 141 may send one copy of the received data to ESC processing database 142 where it may be parsed and stored. Alternatively and/or additionally, ESC processing interface 141 may send a second copy of the received data to ESC processing point 143 in the form of an electronic communication or notification, such as, for example, an email, a message, a docket alert, etc. It is anticipated that, in some embodiments, data may first be entered into ESC database 142, and then may be distributed to ESC processing point 143 by means of ESC processing interface 141.

As shown instep 410, ESC processing point 143 maybe accessed by an agent 220 and the data may be extracted from the electronic communication or notification. In some embodiments, an electronic mailbox may be accessed by means of ESC processing point 143, causing the data to automatically populate the electronic document. In other embodiments, an electronic document template may be opened and the data imported from ESC database 142 or other data file into the electronic document. In either case, the received data is inserted into an electronic document at ESC processing point 143.

Once the received data is inserted into an electronic document, one or more portions of the electronic document may be selectively unsecured by entering a password or identification number into an editable field (step 415) and/or clicking on a selectable area associated with the portion of the electronic document to be unsecured (step 420). As stated above, it is anticipated that the entry of a password or identification may include any combination of letters, numbers, and symbols. Alternatively and/or additionally, other means of verification may be used, such as, for example, voice recognition, identification card/card reader, biometric verification, and the like.

Once the selectable area associated with the portion to be unsecured has been selected, the password may be verified (step 425). If password verification fails (step 425, No), processing returns may return to step 415. If the password is successfully verified (step 425, Yes), the corresponding one or more portion of the electronic document may be unsecured and made available for editing. For example, clicking on item D of FIG. 5 may enable items 20-36 to be unsecured and available for editing. It is anticipated that the portions of the electronic document to be unsecured and available for editing may be determined based on the entered password or identification such that there may be “levels of access.” For example, a first password may be enable access to items 1-19 of FIG. 5, a second password may enable access to items 20-36, and a third password may enable access to the entire document. In some embodiments, it is anticipated that it may be undesirable or unnecessary to require a password and steps 415 and 425 may not be performed. Furthermore, in some embodiments, it is anticipated that the text contained within the selectable area may change when the electronic document is secured/unsecured and/or the document may include a watermark or other indicia to provide an indication of the status of the document. For example, the text of item D of FIG. 5 may change from “Unlock” to “Lock” when the electronic document is unsecured and a “DRAFT” watermark may be applied to the electronic document. Conversely, the text of the selectable area may change to “Unlock” from “Lock” when the electronic document is secured and the “DRAFT” watermark may be removed. In addition, it is anticipated that one or more additional selectable areas may be made visible when the electronic document is unsecured. For example, referring again to FIG. 5, item E may be made visible and available for selection when item D is selected and the electronic document is unsecured.

At step 430, one or more of the fields in the unsecured portion of the form may be edited. Similar to that discussed above, an agent 220 may be required to edit a specific number of fields and/or the agent 220 may be limited to certain entries or data types in predetermined fields, such as, for example, only letters, only numbers, only alphanumeric characters, only certain number and/or letter combinations, specific numbers of characters, specific format, and the like. In addition, the agent 220 may be required to enter data based on previously entered data.

Once editing the fields is complete, the status of the electronic document may be changed (step 435). If the electronic document is to remain unsecured, then no further action may be necessary (step 435, Unsecure). However, if the electronic document is to be secured with the option of returning to the electronic document at a later time for further editing (step 435, Secure), the selectable area associated with securing the desired portion of the electronic document may be selected and the corresponding one or more portions of the electronic document may be secured (step 440). The secured portions may be only the portion editable by the user 210, the portion editable by the agent 220, or it may be the entire electronic document. As discussed above, securing the electronic document prevents data from being altered or amended.

If the electronic document is complete and ready to be finalized (step 435, Finalize), the selectable area corresponding to the finalization of the electronic document may be selected (step 445). When an electronic document is to be finalized, the fields of the electronic document may be permanently secured and the electronic document may become unavailable for any further editing.

Once the selectable area associated with finalizing the document is selected, the editable fields of the electronic document may be validated (step 450). In one exemplary embodiment, the data may be evaluated to determine if it is complete or meets one or more predefined characteristics and/or criteria, e.g., only letters, only numbers, only alphanumeric characters, only certain number and/or letter combinations, specific numbers of characters, specific format, and the like. Alternatively and/or additionally, any dependencies or relationships between the editable fields may be reconciled at this point. If the data in the editable fields fails validation, i.e., the data is incomplete or inconsistent, processing returns to step 430 and the agent 220 may be allowed to alter or amend the data contained in the editable fields. In some embodiments, it may be unnecessary or undesirable to perform validation. If the editable fields are successfully validated or if validation is not performed, processing may move to step 455.

In step 455, one or more portions of the electronic document associated with the selected area may be secured. As states above, securing the electronic document prevents data from being altered or amended and securing of the document may be either temporary or permanent. For example, referring to FIG. 5, selection of item D may cause the portion of the electronic document containing items 20-36 to be temporarily secured, whereas selection of item E may cause the portion of the document containing items 1-36 to be permanently secured.

Once the appropriate one or more portions of the electronic document are secured, the data may extracted and processed through ESC processing interface 141. In addition, the data may be stored in ESC database 142 and may be forwarded through network 130 (step 460). Similarly to that disclosed above with reference to step 330 of FIG. 3, the data may be extracted from the electronic document and inserted into the subject line of an electronic mail.

Different embodiments may be implemented. For instance, the process of FIGS. 3 and 4 may be repeated or performed in varying sequences. For example, in some embodiments, the electronic document may be used as a negotiation tool such that the electronic document may be completed by user 210, responded to by agent 220, amended by user 210, and further responded to by agent 220. Each transfer of the electronic document may require the electronic document to be secured and/or unsecured as disclosed above in reference to FIGS. 3 and 4. Thus, the process may be repeated until a satisfactory result is achieved. A satisfactory final result may be defined by a user 210, agent 220, or computer-executed software process configured to permanently secure the document and prevent any further edits or amendments by user 210, agent 220, etc.

The disclosed embodiments may be implemented with processes involving extended services coverage. The disclosed embodiments may achieve improved processing for extended services coverage application processes. In particular, the disclosed embodiments may provide improved data input, tracking, auditing, and regulatory compliance for extended services coverage. Specifically, the ability to selectively secure and unsecure one or more portions of the form, independently or concurrently with one another, may provide an improved ability to control and verify data input to the electronic forms, to track and monitor changes made to the electronic forms, and to allow for greater auditing capabilities of the electronic forms. In addition, the disclosed embodiments may allow for an improved ability to meet or conform to regulatory requirements, such as the Sarbanes-Oxley Act and the like.

It will be apparent to those skilled in the art that various modifications and variations can be made in the price stabilization method. It is intended that the specification and examples be considered as exemplary only, with a true scope of the disclosed embodiments being indicated by the following claims and their equivalents.

What is claimed is:

1. A method for securing an electronic document, the electronic document having the appearance of a paper-based form, comprising:
providing the electronic document to a user, wherein the electronic document includes one or more portions;
providing one or more selectable areas within the electronic document, wherein the one or more selectable areas is associated with at least one of the one or more portions;
receiving a selection of the at least one or more selectable areas by the user; and
selectively controlling the ability to alter the at least one portion based on the user's selection of the associated one or more selectable areas.

2. The method as in claim 1, further including:
providing the selectable area within the associated portion of the electronic document.

3. The method as in claim 1, further including:
providing the one or more portions, wherein each of the one or more portions includes at least one editable field.

4. The method as in claim 3, wherein selectively controlling includes:
controlling, by the at least one selectable area, the ability to alter the at least one editable field of the associated at least one portion.

5. The method as in claim 1, wherein selectively controlling includes:
controlling the ability to alter the at least one portion based on the user's selection of at least one of an associated button, an associated radio button, or an associated checkbox.

6. The method as in claim 1, wherein providing the electronic document further includes:
forming the one or more portions by logical groupings of a plurality of editable fields.

7. The method as in claim 1, wherein providing the electronic document further includes:
providing one or more editable fields, wherein each of the one or more editable fields is associated with at least one of the one or more portions.

8. The method as in claim 1, wherein providing the electronic document further includes:
providing a plurality of portions, wherein each of the plurality of portions is associated with at least one of the one or more editable fields.

9. The method as in claim 1, further including:
providing the ability to enter a password; and
selectively controlling the ability to alter the at least one portion based on a selection of the selectable and the entered password.

10. A system for securing an electronic document, the electronic document having the appearance of a paper-based form, comprising:
a display;
a memory including program code for selectively securing the electronic document, wherein the electronic document includes one or more portions; and
a processor configured to execute program code to provide the electronic document to the display, provide at least one selectable area within the electronic document, wherein the selectable area is associated with at least one of the one or more portions, and selectively control the ability to alter the at least one portion based on a selection of the associated one or more selectable areas.

11. The system of claim 10, wherein the selectable area is within the associated portion of the electronic document.

12. The system of claim 10, wherein each of the one or more portions includes at least one editable field.

13. The system of claim 12, wherein the at least one selectable area controls the ability to alter the at least one editable field of the associated at least one portion.

14. The system of claim 10, wherein the selectable area includes one of a button, a radio button, or a checkbox.

15. The system of claim 10, wherein the one or more portions are formed by logical groupings of a plurality of editable fields.

16. The system of claim 10, wherein the one or more selectable fields is a plurality of selectable fields and each of the plurality of selectable fields is associated with at least one of the one or more portions.

17. The system of claim 10, wherein the one or more portions is a plurality of portions and each of the plurality of portions is associated with at least one of the one or more selectable fields.

18. The system of claim 10, wherein the processor is configured to execute the program code to:
receive a password from a user; and
selectively control the ability to alter the at least one portion based on a selection of the selectable and the entered password.

19. A method for selectively securing an electronic document, the electronic document having the appearance of a paper-based form, comprising:
providing the electronic document to a user, wherein the electronic document includes one or more portions and each of the one more portions includes at least one editable field;
providing a selectable area within the electronic document, wherein the selectable area is associated with at least one of the one or more portions and controls the ability to alter the at least one editable field included in the associated at least one portion; and
based on a selection of the selectable area, changing a status of the associated portion of the electronic document, wherein the status indicates whether the associated portion may be edited by the user.

20. The method as in claim 19, wherein the one or more portions are formed by logical groupings of a plurality of editable fields.
